(19) United States
(12) Patent Application Publication
(10) Pub. No.: US 2004/0225875 A1
(43) Pub. Date: Nov. 11, 2004

(54) System and method of device information management

(76) Inventors: Chung-Ching Huang, Taipei (TW); Chien-Ping Chung, Taipei (TW)

Correspondence Address: RABIN & Berdo, PC, 1101 14TH STREET, NW, SUITE 500, WASHINGTON, DC, 20005, US

(21) Appl. No.: 10/697,123

(22) Filed: Oct. 31, 2003

(30) Foreign Application Priority Data
May 9, 2003 (TW) 92112653

(51) Int. Cl. G06F 15/177

(52) U.S. Cl. 713/1

(57) ABSTRACT

A system of device information management for use in a computer system is provided. The system includes an application device having a RAM, and a BIOS ROM. The BIOS ROM implements a specific data structure to store device information of the application device. When the computer system boots, the BIOS in the BIOS ROM reads device information, and writes it to the RAM of the application device. The application device then directly loads device information from the RAM. The device driver uses a standard PNP function call to update device information in the BIOS ROM. The BIOS writes the updated device information to the RAM of the application device, and the application device loads the updated device information from the RAM.

### BACKGROUND OF THE INVENTION

1. Field of the Invention

The present invention relates to a system and method of device information management, and particularly to a system and method that uses BIOS (Basic Input/Output System) ROM (Read-Only Memory) to store and manage information for application devices.

2. Description of the Related Art

ROM, such as EEPROM (Electrically Erasable Programmable Read-Only Memory) is a type of non-volatile memory device commonly applied in motherboard and component designs of a computer system. Data stored in EEPROM is secure until software or hardware issues an erase command.

Typically, EEPROM can store LAN (Local Area Network) chip information, such as PHY (Physical) ID (identification), MAC (Media Access Control) address and Vendor/System ID such that corresponding application devices can reference it as needed. The MAC address is a universal unique address provided by LAN card or motherboard vendor at production. Storage of the MAC address in EEPROM ensures that information is available for update with the system.

FIG. 1 is a schematic diagram of conventional device information management. In this case, two application devices (LAN chip 100 and IEEE 1394 chip 110) in the computer system require corresponding EEPROMs 101 and 111 provided to store respective information. After the computer system boots, the LAN chip 100 may load device information, such as PHY ID and MAC address from the EEPROM 101, to provide LAN function. At the same time, the IEEE 1394 chip 110 may also load device information from the EEPROM 111, providing corresponding function. The LAN driver 102 and 1394 driver 112 may also update corresponding EEPROM contents via the LAN chip 100 and IEEE 1394 chip 110 respectively. In this case, one motherboard or computer system may provide many EEPROMs for multiple devices, raising EEPROM costs and impacting system vendors.

In motherboard design, BIOS ROM is a necessary boot device. In most cases, however, the BIOS ROM is not fully occupied by the system BIOS image. Thus an opportunity exists to exploit the unused space on the BIOS ROM to store device information for corresponding application devices.

### SUMMARY OF THE INVENTION

It is therefore an object of the present invention to provide a system and method of device information management that uses BIOS ROM to store and manage device information to relieve the requirement for multiple memory devices and, thereby, costs.

To achieve the above object, the present invention provides a system of device information management for use in a computer system. The system includes an application device having a RAM (Random-Access Memory), and a BIOS ROM. The BIOS ROM implements a specific data structure to store device information of the application device. When the computer system boots, a BIOS in the BIOS ROM reads device information, and writes it to the RAM of the application device. The application device then directly loads device information from the RAM.

The system further includes a device driver corresponding to the application device. The device driver uses a standard PNP (Plug and Play) function call to update device information in the BIOS ROM. The BIOS writes the updated device information to the RAM of the application device, and the application device loads the updated device information from the RAM.

A method of device information management is also provided. First, an application device having a RAM, and a BIOS ROM having a BIOS, are provided in a computer system, in which the BIOS ROM implements a specific data structure to store device information of the application device. When the computer system boots, the BIOS in the BIOS ROM reads device information, and then writes it to the RAM of the application device. Thereafter, the application device loads device information.

Similarly, a device driver corresponding to the application device uses a standard PNP function call to update device information in the BIOS ROM. Then, the BIOS writes the updated device information to the RAM of the application device, and the application device loads the updated device information from the RAM.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram of conventional device information management;

FIG. 2 is a schematic diagram of the architecture of the system of device information management according to the present invention;

FIG. 3 is a flowchart showing the boot process of a computer system according to the present invention;

FIG. 4 is a flowchart showing the update process of device information according to the present invention; and

FIG. 5 is a schematic diagram illustrating an example of device information management according to the present invention.

### DETAILED DESCRIPTION OF THE INVENTION

FIG. 2 illustrates the architecture of the system of device information management according to the present invention. The system is suitable for use in a computer system. The system includes at least an application device 200 and a BIOS ROM 210.

The application device 200 may be a LAN or IEEE 1394 chip, requiring device information, such as PHY ID, MAC address, Vendor/System ID, and others to function. The application device 200 has a RAM 201. Normally, RAM inside the application device is referred to as shadow register.

The BIOS ROM 210 stores a BIOS 211 to provide basic input and output, configuration, hardware test functions, and others, to the computer system. The BIOS ROM 210 implements a specific data structure, such as DMI (Desktop Management Interface) data structure to store device information 212 of the application device 200. In addition, the BIOS 211 may support BIOS PNP and SMBIOS (System Management Basic Input/Output System) specifications.

The SMBIOS specification defines a standard format of product management information to display for motherboard and system vendors. The DMI collects computer information. Users can manage and collect the computer information, such as serial number, computer vendor, serial port information, and information of other components via the DMI and its corresponding data structure. Further, a device driver 202 corresponding to the application device 200 may use a function call, such as BIOS PNP function call to update device information 212 in the BIOS ROM 210. The update process of device information 212 will be discussed later.

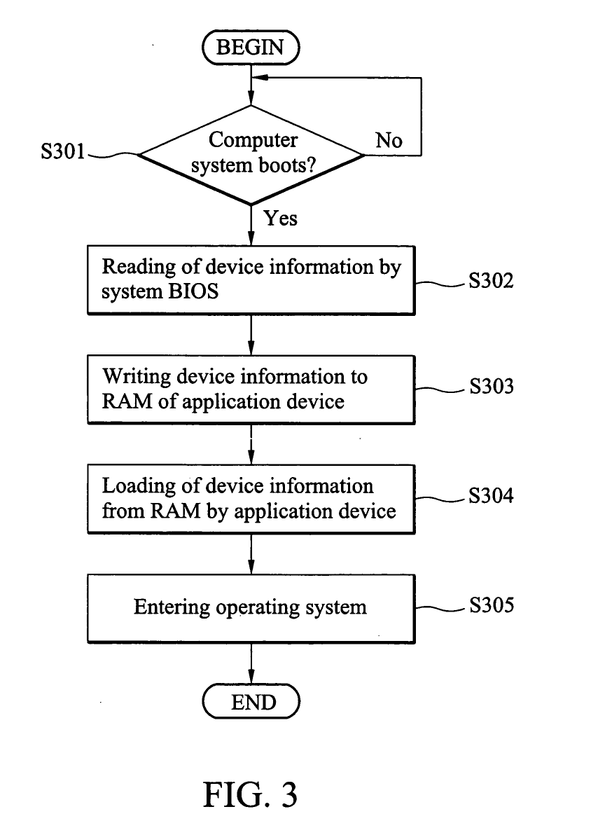

FIG. 3 shows the boot process of the computer system according to the present invention. First, in step S301, it is determined whether the computer system has booted. If not (No in step S301), the flow returns to step S301. If the computer system boots (Yes in step S301), in step S302, the BIOS 211 in the BIOS ROM 210 reads device information 212, and in step S303, writes the data to the RAM 201 of the application device 200. Thereafter, in step S304, the application device 200 loads device information from the RAM 201 directly without reading from outside EEPROM. After, in step S305, the computer system enters an operating system. It should be noted that the related boot process, such as POST (Power On Self Test) performed by the BIOS is not a main feature of the present invention, and as such is omitted.

It also should be noted that the data in the RAM 201 or shadow register is lost when the computer system is powered off. Therefore, when the computer system is powered on again, the BIOS 211 will read device information 212, and write it to the RAM 201 of the application device 200. The application device 200 will load device information from the RAM 201 again.

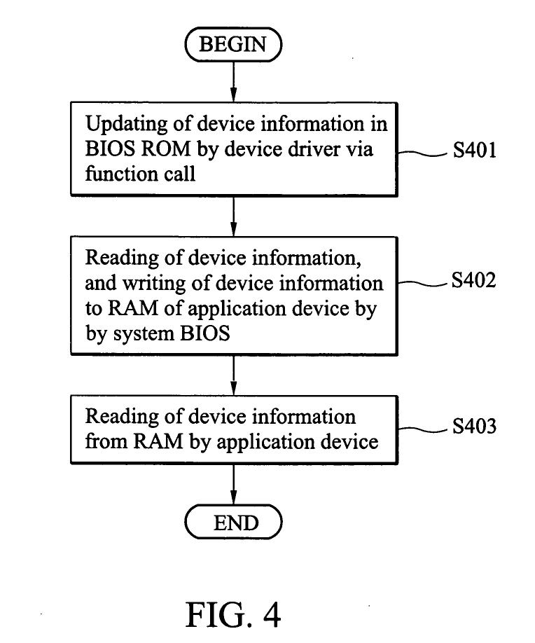

FIG. 4 shows the process of device information update according to the present invention. For the device driver 202 corresponding to the application device 200, in step S401, standard PNP function call updates device information 212 in the BIOS ROM 210.

In step S402, the BIOS 211 writes the updated device information 212 to the RAM 201 of the application device 200. Thereafter, in step S403, the application device 200 reloads the updated device information from the RAM 201.

It should be noted that the system vendor may write device information corresponding to application devices to the BIOS ROM directly in production. In this case, if the BIOS ROM does not store device information in advance, a UI can be provided in the BIOS for device information input. After device information input, the BIOS can write device information to the corresponding RAM.

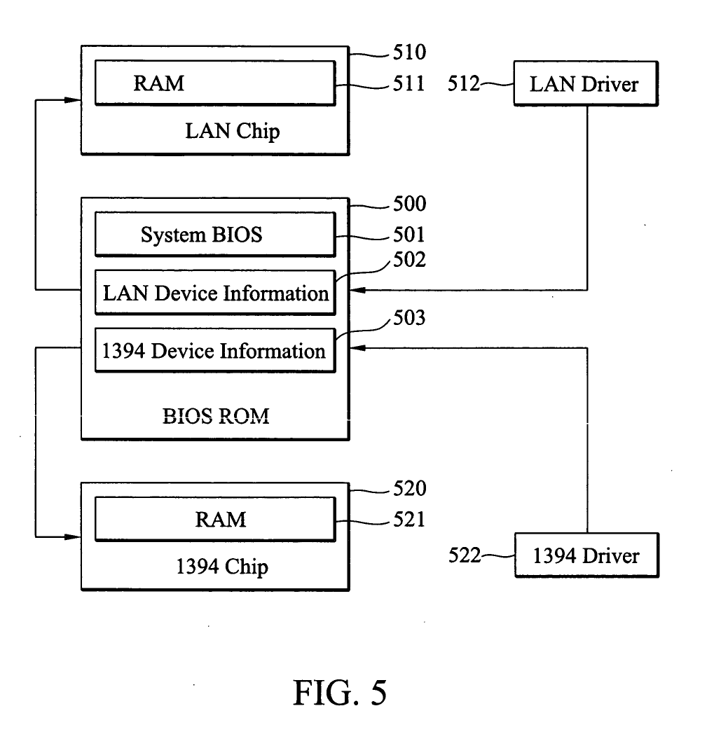

FIG. 5 illustrates an example of device information management according to the present invention. In this case, the computer system includes a LAN chip 510 and an IEEE 1394 chip 520. The BIOS ROM 500 includes BIOS 501 and records LAN device information 502 and 1394 device information 503 corresponding to the LAN chip 510 and the IEEE 1394 chip 520 respectively.

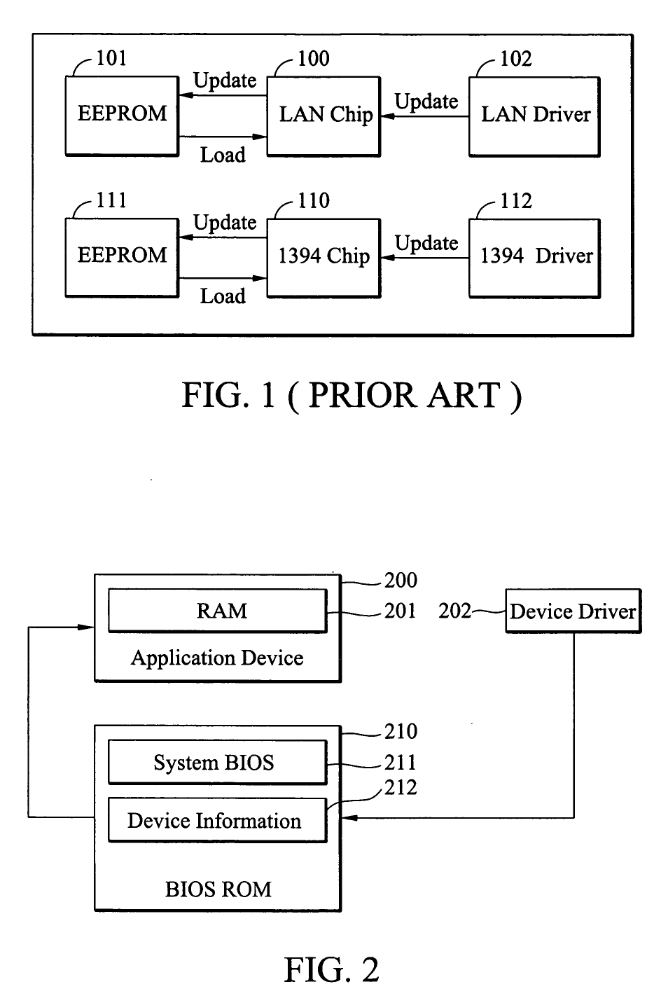

When the computer system boots, the BIOS 501 reads the LAN device information 502 and writes it to the RAM 511 of the LAN chip 510, and reads the 1394 device information 503 and writes it to the RAM 521 of the IEEE 1394 chip 520. Then, the LAN chip 510 loads the LAN device information 502 from the RAM 511, and the IEEE 1394 chip 520 loads the 1394 device information 503 from the RAM 521 directly without reading from outside EEPROMs. In addition, the LAN driver 512 and 1394 driver 522 may use function calls to update the corresponding device information stored in the BIOS ROM 500. After device information is updated, the BIOS 501 writes the updated device information to the corresponding RAM. Comparing FIGS. 5 and 1, the computer system according to the present invention reduces usage of EEPROMs more than that in FIG. 1.

As a result, using the system and method of device information management according to the present invention, the BIOS ROM can store and manage device information for application devices, thereby reducing the number of ROMs corresponding to the application devices in the computer system, thereby reducing costs.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of device information management, comprising:
an application device including a RAM (Random-Access Memory); and
a BIOS (Basic Input/Output System) ROM (Read-Only Memory) including a BIOS and implementing a specific data structure to store device information for said application device.

2. The system of device information management as claimed in claim 1, wherein when said computer system boots, said BIOS reads device information, and writes into said RAM.

3. The system of device information management as claimed in claim 2, wherein said application device loads device information from said RAM.

4. The system of device information management as claimed in claim 1 further comprising a device driver corresponding to said application device to update device information in said BIOS ROM using a standard function call.

5. The system of device information management as claimed in claim 4, wherein said BIOS writes said updated device information into said RAM.

6. The system of device information management as claimed in claim 5, wherein said application device loads said updated device information from said RAM.

7. The system of device information management as claimed in claim 1, wherein said specific data structure is a DMI (Desktop Management Interface) data structure.

8. The system of device information management as claimed in claim 4, wherein said standard function call is a BIOS PNP (Plug and Play) function call.

9. The system of device information management as claimed in claim 1, wherein said application device is a LAN (Local Area Network) chip.

10. The system of device information management as claimed in claim 1, wherein said application device is an IEEE 1394 chip.

11. The system of device information management as claimed in claim 1, wherein device information is a PHY ID (Physical Identification).

12. The system of device information management as claimed in claim 1, wherein device information is a MAC (Media Access Control) address.

13. A method of device information management, comprising steps of:
providing an application device including a RAM (Random-Access Memory);
providing a BIOS (Basic Input/Output System) ROM (Read-Only Memory) including a BIOS; and
implementing a specific data structure to said BIOS ROM to store device information of said application device.

14. The method of device information management as claimed in claim 13 further comprising reading of device information, and writing thereof to said RAM by said BIOS when said computer system boots.

15. The method of device information management as claimed in claim 14 further comprising loading of device information from said RAM by said application device.

16. The method of device information management as claimed in claim 13 further comprising update of device information in said BIOS ROM using a standard function call by a device driver corresponding to said application device.

17. The method of device information management as claimed in claim 16 further comprising writing of said updated device information to said RAM by said BIOS.

18. The method of device information management as claimed in claim 17 further comprising loading of said updated device information from said RAM by said application device.

19. The method of device information management as claimed in claim 13, wherein said specific data structure is a DMI (Desktop Management Interface) data structure.

20. The method of device information management as claimed in claim 16, wherein said standard function call is a BIOS PNP (Plug and Play) function call.

21. The method of device information management as claimed in claim 13, wherein said application device is a LAN (Local Area Network) chip.

22. The method of device information management as claimed in claim 13, wherein said application device is an IEEE 1394 chip.

23. The method of device information management as claimed in claim 13, wherein device information is a PHY ID (Physical Identification).

24. The method of device information management as claimed in claim 13, wherein device information is a MAC (Media Access Control) address.
